(19) United States
(12) Patent Application Publication
(10) Pub. No.: US 2025/0277433 A1
(43) Pub. Date: Sep. 4, 2025

(54) ZERO FLARING OPERATIONS USING NON-METALLIC PIPES

(71) Applicant: Abdulaziz Al-Ajaji, Al Khobar (SA)

(72) Inventor: Abdulaziz Al-Ajaji, Al Khobar (SA)

(21) Appl. No.: 18/568,988

(22) PCT Filed: Aug. 25, 2022
(86) PCT No.: PCT/IB2022/057952

§ 371 Date: Dec. 11, 2023

(51) Int. Cl. E21B 43/34; E21B 41/00; F16L 55/46; F16L 101/12

(52) U.S. Cl. CPC E21B 43/34; F16L 55/46; E21B 41/0071; F16L 2101/12

(57) ABSTRACT

A system for zero-flare energy production operation is disclosed. The system comprises a wellhead located above an oil or gas well, a first pipe segment attached between the wellhead and a first valve to transport gas and liquid extracted from an oil or gas well, a second pipe segment is attached between the first valve and a choke manifold to a separator using a third pipe segment to separate gas and liquid. A fourth pipe segment is attached between the separator and a non-metallic pipe scraper launcher to a non-metallic pipe scraper receiver manifold using a fifth pipe segment. The fifth pipe segment contains a commingled flow of liquid and gas through isolation valve between the non-metallic pipe scraper receiver manifold and a pipeline connected to an energy production network.

### CROSS-REFERENCE TO RELATED APPLICATION

The present application claims the benefit of PCT Application No. PCT/IB 22/57952, filed on Aug. 25, 2022, the entire contents of which are incorporated herein by reference.

### FIELD OF THE INVENTION

The present invention generally relates to the field of zero-flaring energy operation. More particularly, the present invention relates to a system and method for providing zero-flaring energy operation using non-metallic pipes.

### BACKGROUND OF THE INVENTION

In the field of energy production, flaring results in CO2 emissions is considered undesirable by today's environmental standards. At the same time, there are oil wells that are remote from pipeline networks, such as those found in active oilfields. Rather than transporting unwanted gas, flaring in disconnected, shut-in wells is difficult to avoid.

Few existing patent references attempt to address the problems cited in the background as prior art over the presently disclosed subject matter are explained as follows:
A prior art AU 716517 B2 assigned to Jonathan W. Isaacs, entitled “Non-metallic oil well tubing system” discloses a non-metallic oil well tubing system wherein the tubing can be used in oil well applications. The tubing, cable, guides, mandrels and centralizers are shipped separately to the well site. The tubing and cable are run continuously from separate spools, stopping at appropriate lengths to attach any guides and centralizers at the appropriate depths and ultimately to attach the uppermost mount or mandrel. The tubing is flexible and continuous, making it much more efficient to manufacture, transport, and install.
Another prior art CN 108691520 A assigned to Wang Aijiang, et.al., entitled “A kind of natural gas low-cost clean preparation method” discloses a natural gas production method. The method involves a pipeline that is fixed with wellhead. A gas-liquid separator separates the gas and liquid, and then the natural gas is allowed to enter in compressor for supercharging. The pipe fittings such as special valve and oil pipe, cannula exit are used to control the flow in the pipeline. The pipeline can be a coiled tubing, metal tube, specialty metal pipe, non-metallic pipe, special nonmetal pipe or any one or more combinations.
Another prior art U.S. Pat. No. 8,801,938 B2 assigned to Dana R. Allen, entitled “Method and device for underwater recovery of products or pollutants” discloses an apparatus, method, and system for recovering oil from a submerged oil source wherein the system regulates the flow rate between incoming oil mixture, and outgoing oil and natural gas components, e.g., into separators, pipelines, tankers, flare off, etc. An oil/water separator is coupled to the natural gas separator then separates out the contaminant water, resulting in a processed recovered oil product for storage and subsequent refinement. The apparatus includes transfer pipe and pump wherein the pipe transfers the fluid or liquid to the desired location. The cylindrical pipe is rigid, flexible, or a combination of rigid sections with flexible joints.

Though the above-mentioned prior-art disclose non-metallic pipe systems and natural gas extraction systems and methods, they failed to disclose zero-flaring operations to test remote well. Also, the existing systems and methods fail to provide a system to separate the flow of liquid and gas streams.

Therefore, there is a need for a system that performs zero-flaring operations using non-metallic pipes to test a remote well that is disconnected from production lines. Further, there is a need for a non-metallic pipe to transport liquid and gas to the nearest production network to access the potential of the shut-in wells

### SUMMARY OF THE INVENTION

In one embodiment, a system for performing a zero-flaring operation is disclosed. In one embodiment, the system is used for performing zero-flaring operations using one or more non-metallic pipes to test a remote well that is disconnected from production lines using a portable separator. In one embodiment, the non-metallic pipes are used for transporting liquid and gas to the nearest production network to access the potential of the shut-in wells.

In one embodiment, the system comprises a wellhead positioned above a well containing liquid and gas, and one or more pipe segments. In one embodiment, the one or more pipe segments include, but are not limited to, a first pipe segment, a second pipe segment, a third pipe segment, a fourth pipe segment, and a fifth pipe segment or non-metallic pipe. The system further comprises a sixth pipe segment to the flare pit.

In one embodiment, the first pipe segment is attached between the wellhead and a first valve. The first pipe segment is configured to transport gas and liquid extracted from the oil wells and gas wells. In one embodiment, the second pipe segment is attached between the first valve and a choke manifold. The second pipe segment is configured to transport gas and liquid delivered from the first pipe segment through the first valve. In one embodiment, the third pipe segment is attached between the choke manifold and a separator. The separator is configured to separate gas and liquid delivered from the third pipe segment. In one embodiment, the fourth pipe segment is attached between the separator and and a valve manifold or diverter configured to divert the flow of separated gas and liquid to a non-metallic pipe scraper launcher manifold or flare pit.

In one embodiment, the fifth pipe segment is attached between the non-metallic pipe scraper launcher manifold and a non-metallic pipe scraper receiver manifold. The fifth pipe segment is configured to send a commingled flow of gas and liquid. In one embodiment, the fifth pipeline segment is a non-metallic pipe. In one embodiment, the fifth pipe segment comprises one or more non-metallic pipe segments in parallel configured to send gas and liquid separately or commingled flow to the pipeline of the energy production network.

In one embodiment, the system further comprises a connection between the non-metallic pipe scraper receiver manifold and a pipeline connected to an energy production network. The non-metallic pipe scraper receiver manifold is configured to send the commingled flow of gas and liquid through the connection to the pipeline controlled by a valve.

In one embodiment, the system further comprises a portable generator configured to supply electricity to at least one air compressor and an emergency shut down (ESD). In one embodiment, the at least one compressor is configured to supply compressed air to the emergency shut down (ESD). In one embodiment, the system further comprises one or more couplings configured to install two non-metallic pipe ends together. In one embodiment, the non-metallic pipe ends are inserted into the couplings using a mandrel insertion press. The couplings are positioned between two non-metallic pipes while using at least one flanges at end connections with the manifolds. In one embodiment, the flange is connected between the non-metallic pipe and the non-metallic pipe scraper launcher manifold. In one embodiment, the flange is connected between the non-metallic pipe and the the non-metallic pipe scraper receiver manifold. In one embodiment, each coupling and flange comprises one or more vent holes configured to release the gas that permeates via an inner layer of the non-metallic pipe. The vent holes are connected to a cylinder with a Hydrogen Sulfide (H₂S) scavenger fluid column to scavenge Hydrogen sulfide (H₂S) from gases that are permeated from the non-metallic pipe. In one embodiment, the system further comprises a portable crimping tool configured to crimp the couplings and the non-metallic pipe.

The present invention provides a method for zero flaring using non-metallic pipes to test a remote well that is disconnected from the production lines using a portable separator, then take the separated liquid and gas and transport them as commingled flow using the non-metallic pipe to the nearest production network or transport each phase independently through separate non-metallic pipes. Therefore, the present invention eliminates the need to flare the separated gas and instead sends it to a production line. Additionally, the ability to transport produced liquids safely and easily to the production network allows operators to assess the potential of shut-in wells. As a result, based on well test results, operators can put together work plans that can capture any found production or economic opportunity from such wells.

### BRIEF DESCRIPTION OF THE DRAWINGS

FIG. 1 shows a layout of the functional elements of a system for performing a zero-flaring operation using one or more non-metallic pipes in an embodiment of the present invention.

FIG. 2 shows a method for performing a zero-flaring operation using one or more non-metallic pipes in an embodiment of the present invention.

FIG. 3 shows a cut-sectional view of a non-metallic pipe in one embodiment of the present invention.

FIG. 4 shows a perspective view of a non-metallic pipe reel during the yard trail of the prototype in one embodiment of the present invention.

FIG. 5 shows a perspective view of a self-loading reel trailer with a re-spooler in one embodiment of the present invention.

FIG. 6 shows a perspective view of a hydraulic pump in one embodiment of the present invention.

FIG. 7 shows a perspective view of a mandrel insertion press in one embodiment of the present invention.

FIG. 8 shows a perspective view of a crimper in one embodiment of the present invention.

FIG. 9 shows a graph illustrating a diagnostic plot for a leak scenario in one embodiment of the present invention.

FIG. 10 shows a graph illustrating a diagnostic plot for an obstruction scenario in one embodiment of the present invention.

FIG. 11 shows a graph illustrating a diagnostic plot for a production line pressure increase scenario in one embodiment of the present invention.

FIGS. 12-14 show various perspective views of the re-spooling process during yard trial of the prototype in one embodiment of the present invention.

FIG. 15 shows a perspective view of a U-shaped alignment of the non-metallic pipe during re-spooling process in one embodiment of the present invention.

FIG. 16 shows a process flow diagram of a zero flaring operation using non-metallic pipes and mobile gas compression systems in one embodiment of the present invention.

FIG. 17 shows a table displaying the effects of H₂S at different concentration levels in one embodiment of the present invention.

FIG. 18 shows a perspective view of a coupling with one or more vent holes in one embodiment of the present invention.

FIG. 19 shows a perspective view of an H₂S scavenger column in one embodiment of the present invention.

FIG. 20 shows a perspective view of a prototype of the H₂S scavenger column in one embodiment of the present invention.

### DETAILED DESCRIPTION

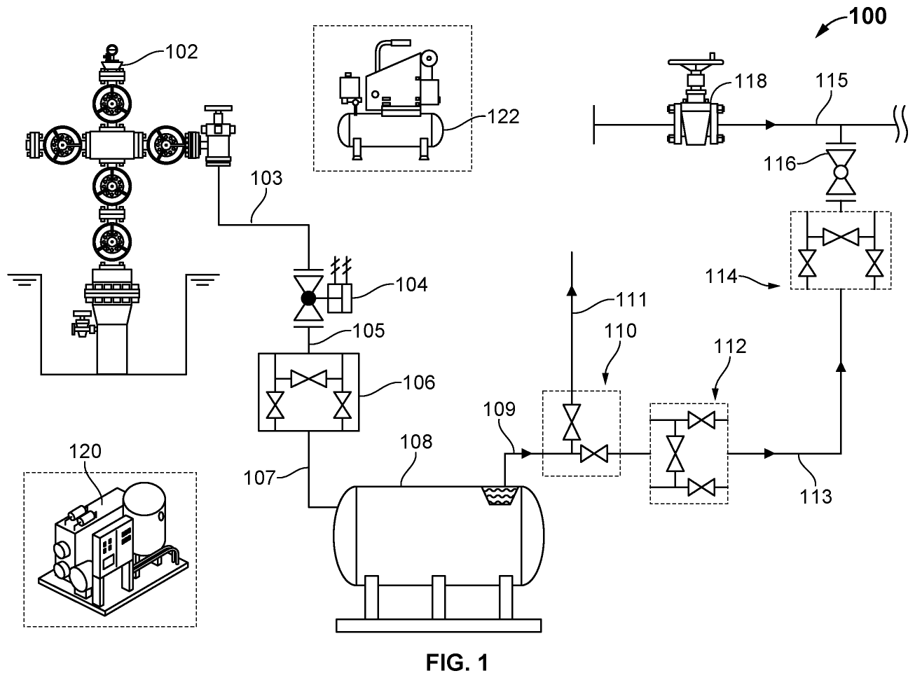

FIG. 1 shows a functional layout of a system 100 for performing a zero-flaring operation, according to an embodiment of the present invention. In one embodiment, the system 100 is used for performing zero-flaring operations using one or more non-metallic pipes to test a remote well that is disconnected from production lines using a portable separator. In one embodiment, the non-metallic pipes are used for transporting liquid and gas to the nearest production network to access the potential of the shut-in wells.

In one embodiment, the system 100 comprises a wellhead 102 positioned above a well containing liquid and gas, and one or more pipe segments. In one embodiment, the one or more pipe segments include, but are not limited to, a first pipe segment 103, a second pipe segment 105, a third pipe segment 107, a fourth pipe segment 109, and a fifth pipe segment or non-metallic pipe 113. The system 100 further comprises a sixth pipe segment 111 to the flare pit.

In one embodiment, the first pipe segment 103 is attached between the wellhead 102 and a first valve or bleeder valve 104. The first pipe segment 103 is configured to transport gas and liquid extracted from the oil wells and gas wells. In one embodiment, the second pipe segment 105 is attached between the first valve 104 and a choke valve manifold or choke manifold 106. The second pipe segment 105 is configured to transport gas and liquid delivered from the first pipe segment through the first valve 104.

In one embodiment, the third pipe segment 107 is attached between the choke manifold 106 and a separator 108. The separator 108 is configured to separate gas and liquid delivered from the third pipe segment 107. In one embodiment, the separator 108 may be a three-phase separator used to separate water, oil, and gas streams. In one embodiment, the fourth pipe segment 109 is attached between the separator 108 and a valve manifold or diverter 110 configured to divert the flow of separated gas and liquid to a non-metallic pipe scraper launcher manifold 112 or flare pit 111. In one embodiment, the fourth pipe segment 109 diverts the flow of separated gas and liquid to the non-metallic pipe scraper launcher manifold 112 or flare pit through the valve manifold 110 via separate pipes. In one embodiment, at least two independent non-metallic pipe systems/flow networks are utilized to transport the liquid and gas separately or water, oil, and gas separately in the case of a three-phase separator. In another embodiment, a single non-metallic pipe system with a three-phase separator may be utilized to transport the liquid and gas separately or water, oil, and gas separately. Further, both liquid and gas are commingled in one non-metallic pipe system 113.

In one embodiment, the fifth pipe segment 113 is attached between the non-metallic pipe scraper launcher manifold 112 and a non-metallic pipe scraper receiver manifold 114. The fifth pipe segment 113 is configured to send a commingled flow of gas and liquid. In one embodiment, the fifth pipeline segment 113 is a non-metallic pipe. In one embodiment, the fifth pipe segment 113 comprises one or more non-metallic pipe segments in parallel configured to send gas and liquid separately to the pipeline 115 of the energy production network.

In one embodiment, the system 100 further comprises a connection 116 between the non-metallic pipe scraper receiver manifold 114 and a pipeline 115 connected to an energy production network. The non-metallic pipe scraper receiver manifold 114 is configured to send the commingled flow of gas and liquid through the connection 116 to the pipeline 115 controlled by a valve 118.

In one embodiment, the system 100 further comprises a portable generator 120 configured to supply electricity to at least one air compressor and an emergency shut down (ESD). In one embodiment, the at least one compressor 122 is configured to supply compressed air to the emergency shut down (ESD). In one embodiment, the system 100 further comprises one or more couplings configured to install two non-metallic pipe ends together. In one embodiment, the non-metallic pipe ends are inserted into the couplings using a mandrel insertion press. The couplings are positioned between two non-metallic pipes while using at least one flange at end connections with the manifolds. In one embodiment, the flange is connected between the non-metallic pipe and the non-metallic pipe scraper launcher manifold 112. In one embodiment, the flange is connected between the non-metallic pipe and the non-metallic pipe scraper receiver manifold 114. In one embodiment, each coupling and flange comprises one or more vent holes configured to release the gas that permeates via an inner layer of the non-metallic pipe. In one embodiment, the system 100 further comprises a portable crimping tool configured to crimp the couplings and the non-metallic pipe.

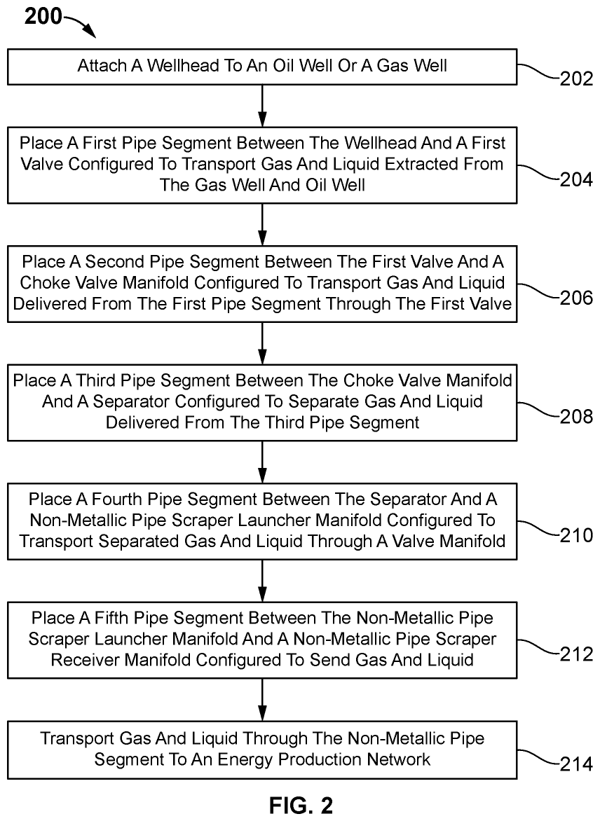

FIG. 2 shows a method 200 for performing zero-flaring energy production operation, according to one embodiment of the present invention. The method 200 comprises the following steps. At step 202, a wellhead 102 is attached to an oil well or a gas well. At step 204, a first pipe segment 103 is placed between the wellhead 102 and a first valve 104. In one embodiment, the first pipe segment 103 is configured to transport gas and liquid extracted from the gas well and oil well. At step 206, a second pipe segment 105 is placed between the first valve 104 and a choke valve manifold 106. In one embodiment, the second pipe segment 105 is configured to transport gas and liquid delivered from the first pipe segment 103 through the first valve 104.

At step 208, a third pipe segment 107 is placed between the choke valve manifold 106 and a separator 108. In one embodiment, the separator 108 is configured to separate gas and liquid delivered from the third pipe segment 107. At step 210, a fourth pipe segment 109 is placed between the separator 108 and a valve manifold or diverter 110 configured to divert the flow of separated gas and liquid to a non-metallic pipe scraper launcher manifold 112 or flare pit 111.

At step 212, a fifth pipe segment 113 is placed between the non-metallic pipe scraper launcher manifold 112 and a non-metallic pipe scraper receiver manifold 114. In one embodiment, the fifth pipe segment 113 is configured to send gas and liquid. At step 214, the gas and liquid are transported through the non-metallic pipe segment 113 to an energy production network. In one embodiment, the fifth non-metallic pipe segment 113 transports a commingled flow of gas and liquid. The non-metallic pipe scraper receiver manifold 114 is configured to send the commingled flow of gas and liquid through the connection 116 to the pipeline 115 controlled by a valve 118.

In one embodiment, the fifth pipeline segment 113 is a non-metallic pipe having one or more non-metallic pipe segments in parallel configured to send gas and liquid separately or commingled flow to the pipeline 115 of the energy production network. In one embodiment, a connection 116 between the non-metallic pipe scraper receiver manifold 114 and a pipeline 115 to the energy production network. In one embodiment, the method 200 utilizes a portable generator 120 configured to supply power or electricity to at least one air compressor. In one embodiment, the method 200 further utilizes at least one compressor 122 configured to supply compressed air to an emergency shut down (ESD).

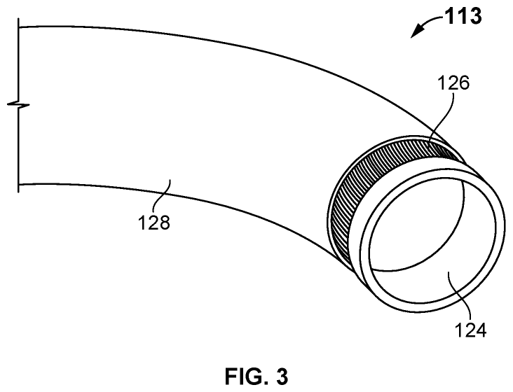

FIG. 3 shows a cut-sectional view of a non-metallic pipe 113, according to one embodiment of the present invention. In one embodiment, the non-metallic pipe 113 is made of three layers. In one embodiment, the three layers include an innermost layer or thermoplastic liner 124, a reinforcement layer 126, and an outermost layer or thermoplastic jacket 128. The reinforced layer 126 provides strength to the non-metallic pipe 113. The thermoplastic jacket 128 protects the load-bearing layer. In one embodiment, the non-metallic pipes 113 are continuous pipes with a maximum length of about 1000 m. In one embodiment, the non-metallic pipes 113 are spooled on special mobile reels. In one embodiment, the continuous feature facilitates fast and easy installation with fewer connections and less disturbance to impacted parties, such as the environment and different stakeholders involved in the operation. The non-metallic pipes 113 reduce environmental impacts and soil disturbances as these pipes can be trenched with a narrower trench and right of the way compared to steel line pipe. In one embodiment, the non-metallic pipes 113 are also plowed in without trenching.

The present invention allows testing wells with flow rates ranging from few hundred barrels per day to significantly higher flow rates. Eliminating gas flaring prevents about thousands of metric tons of CO₂ from being released to the atmosphere. In one embodiment, the non-metallic pipes 113 are capable of transporting fluids at a predefined temperature with low pressure drop along the pipe length. In some embodiments, the non-metallic pipes 113 may have different dimensions and capacities.

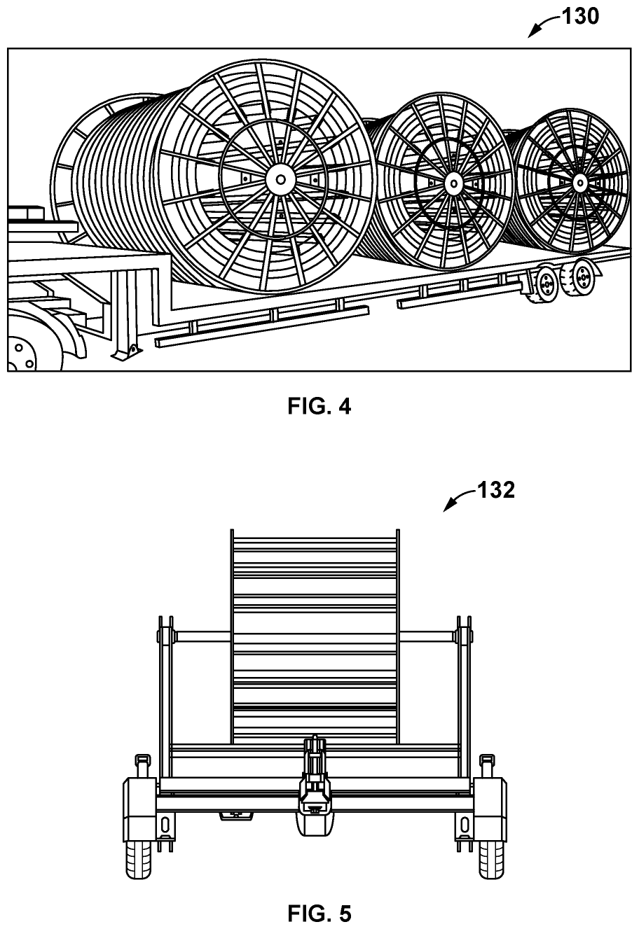

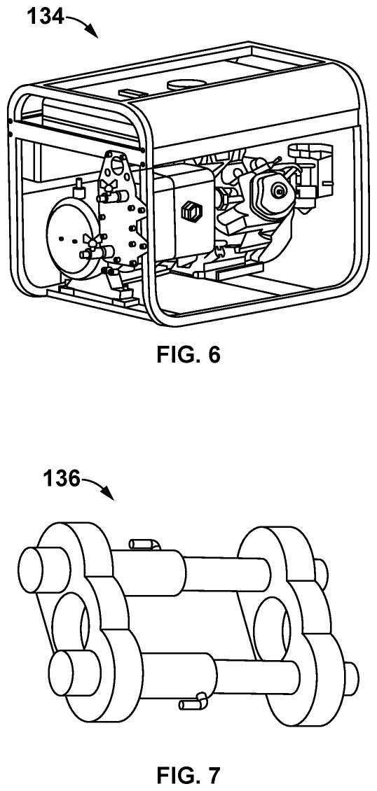

FIGS. 4-6 show a perspective view of a non-metallic pipe reel 130, a self-loading reel trailer 132, and a hydraulic pump 134, according to one embodiment of the present invention. In one embodiment, the non-metallic pipes are spooled off on one or more non-metallic pipe reels or special mobile reels 130 (as shown in FIG. 4). In one embodiment, the non-metallic pipe reels 108 are loaded on self-loading reel trailer 132 with a re-spooler (as shown in FIG. 5). In one embodiment, the self-loading reel trailer 132 is able to handle at least one reel and is ideal for stringing or re-spooling continuous length of non-metallic pipe. In some embodiments, the reel may have different dimensions and capacities for stringing and re-spooling the continuous length of non-metallic pipe. In one embodiment, the self-loading reel trailer 132 with the re-spooler comprises a hydraulic pump configured to rotate the reel and re-spool the pipe back on it. In one embodiment, the hydraulic power unit 134 with an electric start or pump is configured to supply hydraulic oil to the mandrel insertion press 136 and crimper 138.

FIG. 7 shows a perspective view of a mandrel insertion press 136, according to one embodiment of the present invention. The mandrel insertion press 136 is used to force press the non-metallic pipe 113 with coupling or flange. At one side of the mandrel insertion press 136, a clamp is positioned. The clamp holds on the non-metallic pipe segment 113 at the designated distance from its end (designated distance is based on non-metallic pipe size). On the other side of the mandrel insertion press 136, a flange is positioned. In one embodiment, the flange is connected to the mandrel insertion press 136 if the non-metallic pipe 113 is connected to scraper launcher manifold 112 or scraper receiver manifold 114. In another embodiment, the coupling is connected to the mandrel insertion press 136 if the non-metallic pipe 113 is connected to another non-metallic pipe. The mandrel insertion press 136 is used to force press the non-metallic pipe 113 with coupling or flange.

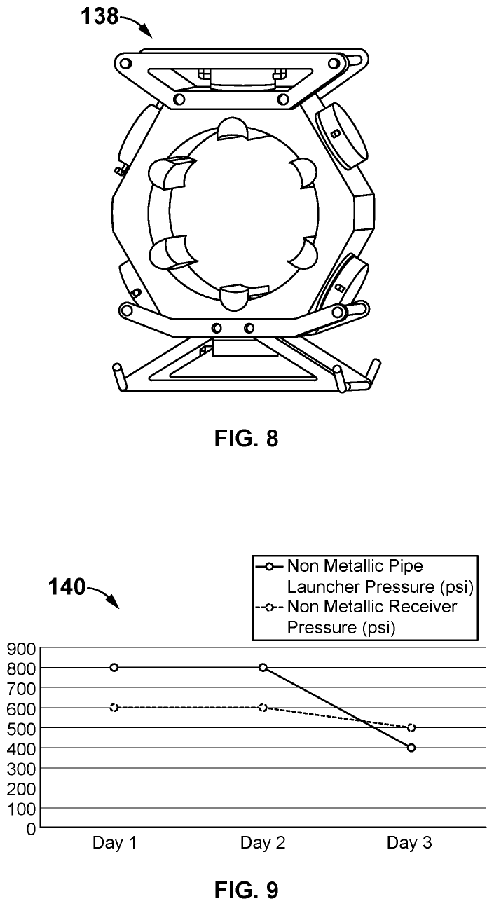

FIG. 8 shows a perspective view of a crimper 138, according to one embodiment of the present invention. In one embodiment, the crimper 138 is used to crimp the coupling or the flange on non-metallic pipe 113. The flange is connected at the non-connected well location and the tie-in point to the scraper launcher manifold 112 and scraper receiver manifold 114. The non-metallic pipe 113 is anchored with one or more sand piles.

FIGS. 9-11 show various diagnostics plots, according to one embodiment of the present invention. In the scenario of non-metallic pipe leak 140, the pressure at scraper launcher manifold 112 drops, and the pressure at scraper receiver manifold 114 drops to a value close to the production line pressure downstream of the scraper receiver manifold 114 (as shown in FIG. 9).

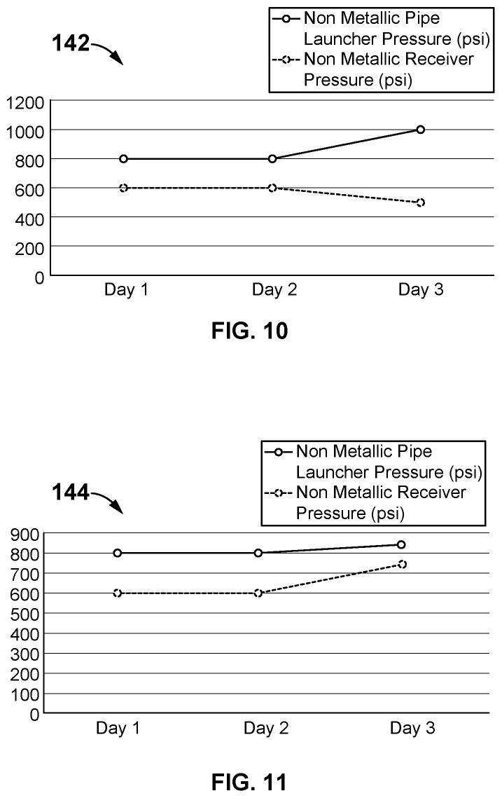

In the scenario of non-metallic pipe blockage 142, the pressure at scraper launcher manifold 112 increases, and the pressure at scraper receiver manifold 114 drops to a value close to the production line pressure downstream of the scraper receiver manifold 114 (as shown in FIG. 10).

In the scenario of an increase in the production line pressure 144, both the pressure at the scraper launcher manifold 112 and scraper receiver manifold 114 increase. This causes back pressure on the producing well (as shown in FIG. 11).

According to the present invention, to reduce the potential of liner deformation due to rapid de-pressurization in oil and gas operations taking place at temperatures above 38° C. (100° F.), it is required to slowly depressurize the non-metallic pipe 113 at no more than 500 psi per hour down to 100 psi and hold for a period of time as indicated below. In one embodiment, the operational temperature is in the range from about 100 to about 120° F., holding at 100 psi for 1 hour. In another embodiment, the operational temperature is in the range from about 121 to about 140° F., holding at 100 psi for 2 hours. In yet another embodiment, the operational temperature is in the range from about 141 to about 160° F., holding at 100 psi for 8 hours. In still another embodiment, the operational temperature is in the range from about 161 to about 200° F., holding at 100 psi for 24 hours.

During the sour flow-back operation and due to high pressure and temperature, some of the sour gas permeate through the liner to the reinforcement layer. During the depressurization hold period, that gas diffuses back through the liner to the pipe inside. When the pipe is cut at the fittings (couplings and flanges), it is expected that minor permeated gas will vent. This is a normal phenomenon. Flushing with cold fluids (e.g., water) delays the gas desorption process. Further, it is required to utilize warm nitrogen at temperatures not less than 40° C. and not more than 55° C. while flushing the line. This will cause the permeated gases to desorb out.

In one embodiment, the appearance of minor gases when the fittings are cut after the completion of the zero-flaring job is due to the absorption/saturation of the polyethylene liner with gases during the operation and the subsequent desorption.

This phenomenon is normal and expected; since all materials will experience it, although at different rates of absorption and desorption. In one embodiment, the intensity of the gas permeation through the liner will depend on factors like temperature, pressure, molecule size, and diffusion coefficient among others. Normally the gas is absorbed, permeates the liner, and travels through the annular space to the vent hole where it is slowly released. In carbon steel pipe, permeation happens through itself, flanges, and other fittings. Optionally, wrapping fittings are provided during short-term temporary installations.

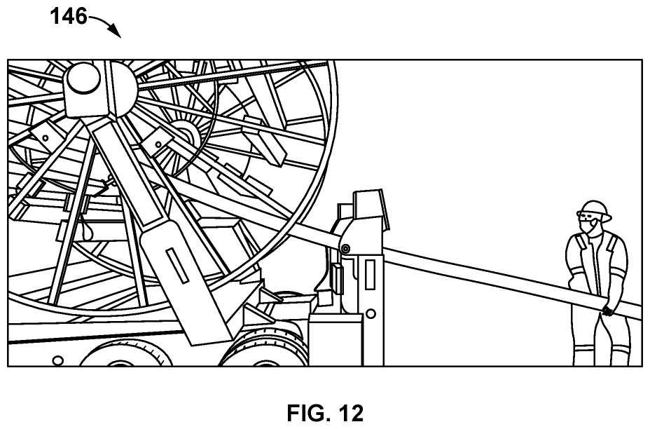

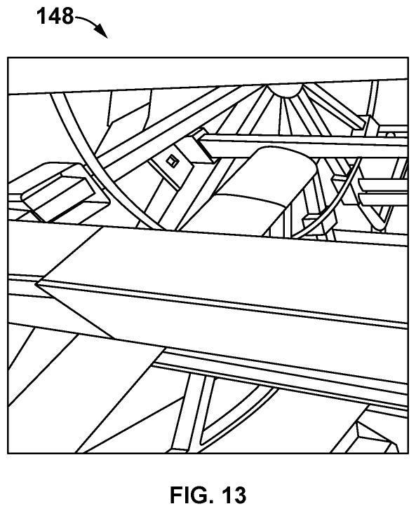

FIGS. 12-14 show various perspective views of the re-spooling process (146, 148, and 150), according to one embodiment of the present invention. Before re-spooling, make sure that the line was flushed and purged properly (as shown in FIG. 12). In one embodiment, the non-metallic pipe 113 is recovered, re-spooled, and re-used in the case of surface installations. In one embodiment, the number of times the pipe can be used will depend on the condition of the pipe and the absence of damage, bends (kinks), or deep indentations. In order to perform the re-spooling, it is required to have a self-loading reel trailer with the re-spooler that has the necessary hydraulic mechanisms to rotate the reel and re-spool the pipe back on it (as shown in FIG. 12).

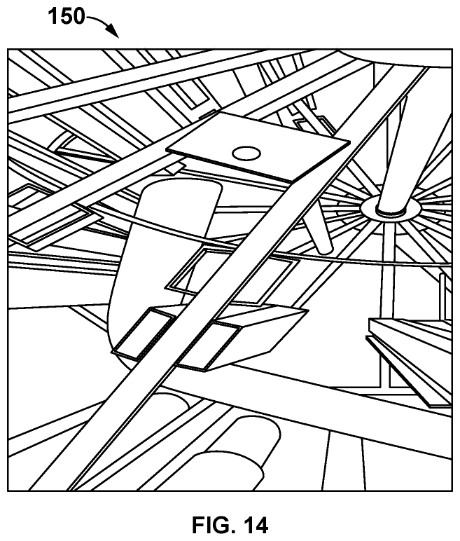

During re-spooling, it is necessary to cut/discard all of the line fittings, whether a flange or coupling. To start the re-spooling process, insert the end of the pipe between the wood traverses to tie the pipe to one of the reel sides (as shown in FIG. 14).

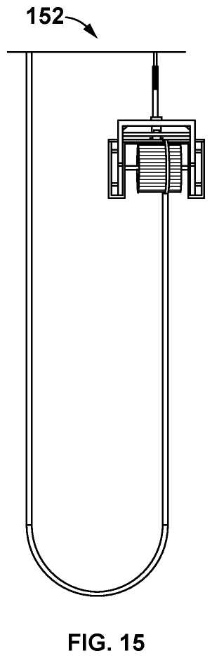

FIG. 15, shows a perspective view of a U-shaped non-metallic pipe alignment 152, according to one embodiment of the present invention. In one embodiment, the non-metallic pipe is laid in a fashion to achieve the U-shaped alignment during re-spooling. In one embodiment, this is accomplished by hand or using a pick-up truck, or available equipment. In one embodiment, the non-metallic pipe is laid in such a fashion to reduce the load on the trailer re-spooler. In one embodiment, the U-shaped pipe alignment 152 has a diameter greater than the pipe's bending diameter. In one embodiment, the length of the shorter side must be not more than 50 m to allow the self-loading reel with re-spooler to pull the pipe smoothly. In one embodiment, during re-spooling one operator must control the self-loading reel with re-spooler, and another operator should guide the pipe to the reel. In one embodiment, further two operators should stay near the U-shaped pipe 152 to make sure that the diameter is greater than the bending diameter. In one embodiment, further communication and visibility between the operators are very important during re-spooling.

In one embodiment, when the length of the shorter side of the pipe becomes 5 m, the operators have to stop re-spooling, and drive the car with the self-loading reel with re-spooler forward for another 50 m to ensure having a 50 m short side length of pipe. In one embodiment, whilst driving the two operators should stay near the U-shaped pipe area. In one embodiment, continue re-spooling again. In one embodiment, all the coupling fittings are cut out and the pipes are cut back one and a half (1.5 m) meters in each direction, and are connected to the pipe ends again with a temporary spool coupling. In one embodiment, the pipes being reconnected were originally one pipe but were cut to accommodate a certain job.

In one embodiment, the system of the present invention discloses the combined use of mobile gas compression unit to allow the well to produce at very low wellhead pressure (thus reviving such wells) and have that production flow through the non-metallic pipe to the nearest production tie-in point. In one embodiment, since the produced gas is not flared, this process is named “Zero Flaring Operation using Non-Metallic Pipes and Mobile Gas Compression Systems”

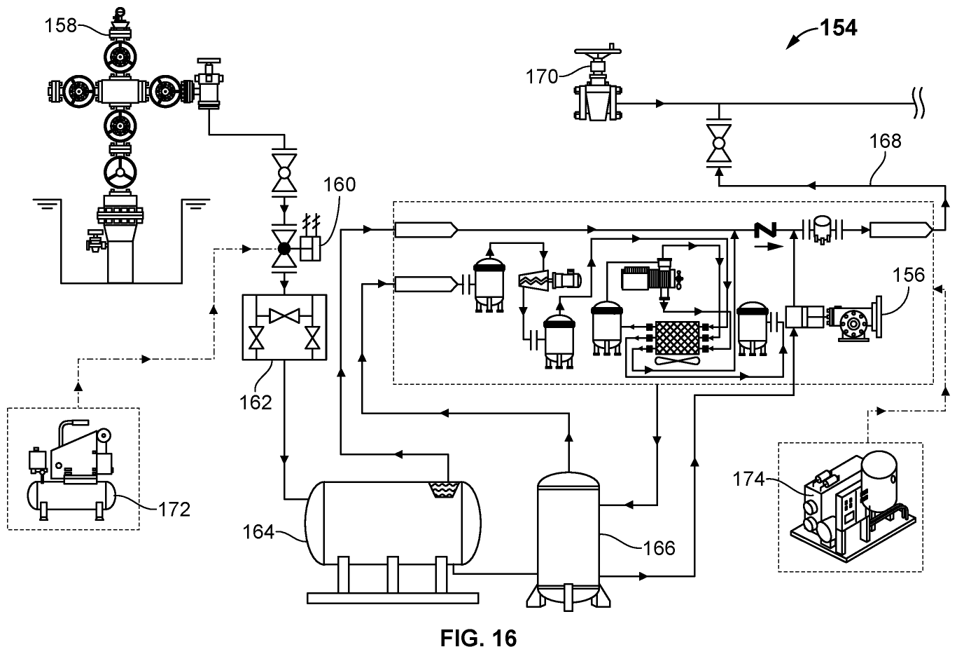

FIG. 16, shows a process flow diagram of a system 154 for performing a zero flaring operation using non-metallic pipes and mobile gas compression systems, according to one embodiment of the present invention. In one embodiment, the flow path starts from the wellhead 158 to the choke manifold 162 and then to a separator kit or separator 164 which separates the flow into liquid stream and gas stream. In one embodiment, a 10K ESD panel 160 is used to control the surface safety valve (i.e., stopping flow from the well) in case of an emergency. In one embodiment, the separator 164 may be a three-phase separator that separates water, oil, and gas streams. In one embodiment, the separated liquid stream flows to a surge tank 166 and from the surge tank 166 to a mobile gas compression unit 168 via an additional pipe 156. In one embodiment, the separated gas stream flows from the separator 164 to the mobile gas compression unit 168. In one embodiment, any separated gas from the surge tank 166 may flow to the mobile gas compression unit 168. In one embodiment, the mobile gas compression unit 168 pumps the liquid, compress the gas and commingle the flow together to a common discharge point. In one embodiment, the commingled stream flows to the scraper launcher manifold from which it flows through the non-metallic pipe connected to a drop spool 170. In one embodiment, an air compressor 172 is used to provide a compressed air to flow to an emergency shut down IESD) for zero-flaring operation. In one embodiment, a power generator 174 is used to supply electricity to the mobile gas compression unit 168.

### Zero Flaring Operations for Sour Flow-back Applications

During the flow-back process using non-metallic pipe, the produced oil and gas flows through the non-metallic pipe to the nearest production tie-in point. In one embodiment, some of the gas permeates through the vent hole in the couplings and flanges of the non-metallic pipe.

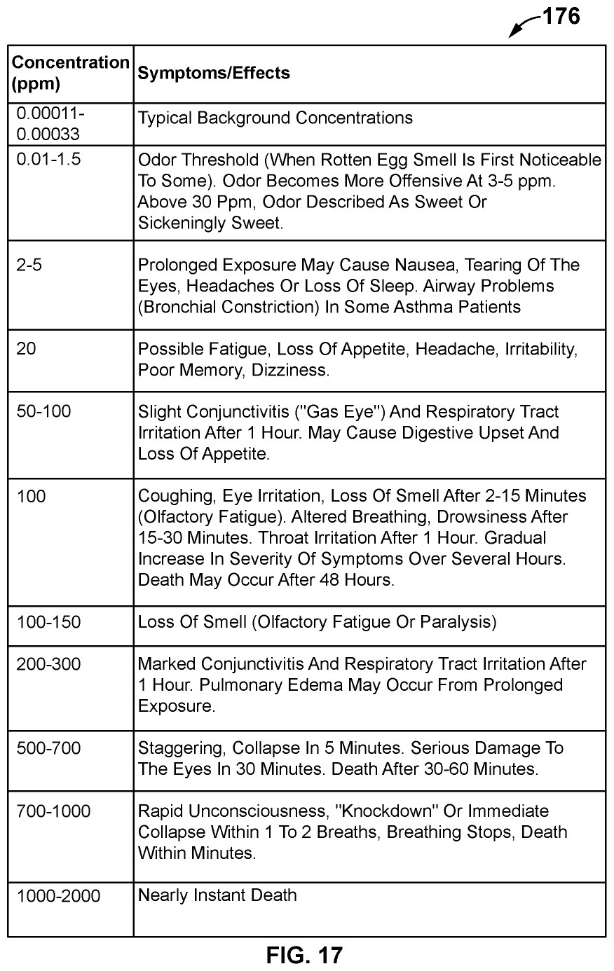

FIG. 17 shows a table 176 containing a list of health effects at various levels, according to one embodiment of the present invention. H₂S is extremely toxic to human and even animal life. It is extremely corrosive to most metals as it can cause cracking of drill pipe and tubular goods and destruction of testing tools and wire lines. Also, it corrodes the pipelines. It is heavier than air and will accumulate in low places. The human odor detection limit starts from about 0.01 ppm to about 30 ppm—where the smell is like a rotten egg smell. This means that H₂S presence may be detected long before it reaches a hazardous level. Once concentrations exceed 150 parts per million (ppm), H₂S may cause olfactory fatigue, affecting the sense of smell such that the hazard is not recognized. Acute effects of exposure to H₂S include headaches, nausea, convulsions, coma, and death.

During flow-back operations of sour wells, the gas contains H₂S. An H₂S scavenger is used to mitigate the effect of H₂S. In one embodiment, the H₂S scavenger scavenges the H₂S in the gas that permeates through the vent hole within the couplings and flanges of non-metallic pipe to various concentrations.

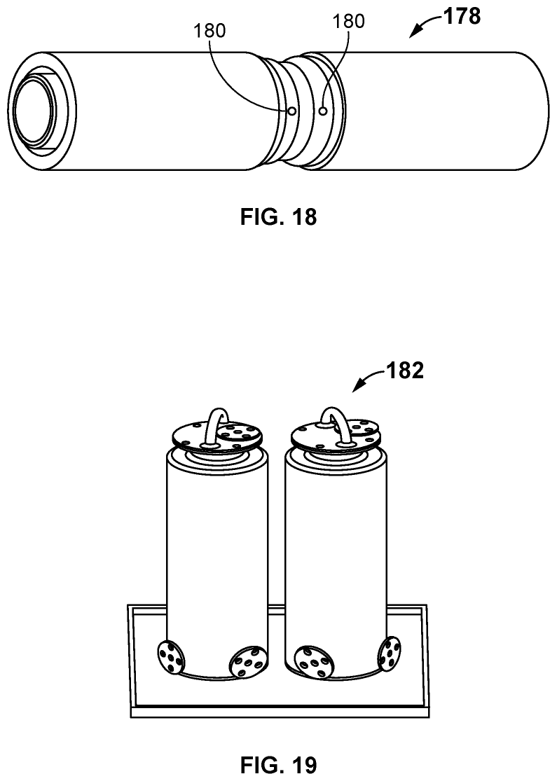

FIG. 18 shows a perspective view of one or more vent holes 180 of a coupling 178, according to one embodiment of the present invention. In one embodiment, the vent holes 180 are provided in the couplings 178 and flanges of the non-metallic pipes. In one embodiment, a little portion of the gases permeates through an inner layer of the non-metallic pipe under high temperatures and pressures. In one embodiment, the gases then get released from the vent holes 180 in the couplings and flanges.

FIG. 19 shows a perspective view of an H₂S scavenger column 182, according to one embodiment of the present invention. In one embodiment, during the flow back testing of sour wells, a proprietary system will be used. The vent holes 180 are connected to a cylinder with a Hydrogen Sulfide (H₂S) scavenger fluid column 182 to scavenge Hydrogen sulfide (H₂S) from gases that are permeated from the non-metallic pipe. In this system, the vent holes 180 in couplings and flanges of the non-metallic pipe are connected to the cylinder with H₂S scavenger fluid. In one embodiment, the permeated gases flow through the vent holes 180 and bubble up in the H₂S scavenger column 182 where the H₂S will be scavenged from the permeated gas.

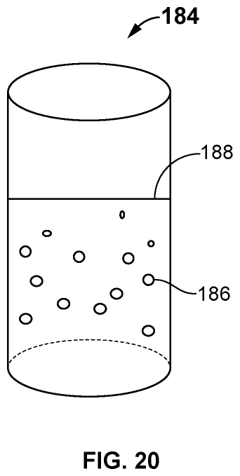

FIG. 20 shows a perspective view of an H₂S scavenger column prototype 184, according to one embodiment of the present invention. In one embodiment, the H₂S scavenger column prototype 184 comprises a cylinder with the gas bubbles 186 representing the permeated gas that comes from the vent holes 180 in the couplings and flanges of the non-metallic pipe. In one embodiment, these gas bubbles contain H₂S. In one embodiment, as these gas bubbles rise through the H₂S scavenger liquid column prototype 184, the H₂S is scavenged. Finally, the gas bubbles reach the surface of the H₂S scavenger liquid level or scavenger level 188 and escape to the atmosphere.

Advantageously, the system of the present invention eliminates gas flaring that prevents thousands of metric tons of CO₂ from being released into the atmosphere. The non-metallic pipes are durable and easy to handle, the pipes are designed and tested to withstand high pressure and temperatures to transport produced oil and gas from wells to the production manifold of an end user. Also, the non-metallic pipes are lighter in weight. The non-metallic pipes are easy to install with fewer connections and low cost compared to carbon steel pipes. The non-metallic pipes do not need regular inspection and maintenance which saves significant cost and time. And also, the non-metallic pipes eliminate the need to flare the separated gas and instead sending it to the production line, and based on well test results operators can put together work plans that can capture any found production or economic opportunity from such wells. Further, the process allows testing wells with higher flow rates. The elimination of gas flaring would prevent the toxic gases from being released to an atmosphere.

What is claimed is:

1. A system for zero-flare energy production operation, comprising:
a wellhead attached to an oil well or gas well;
a first pipe segment attached between the wellhead and a first valve, wherein the first pipe segment is configured to transport gas and liquid extracted from the gas well and oil well;
a second pipe segment attached between the first valve and a choke valve manifold, wherein the second pipe segment is configured to transport gas and liquid delivered from the first pipe segment through the first valve;
a third pipe segment attached between the choke valve manifold and a separator, wherein the separator is configured to separate gas and liquid delivered from the third pipe segment;
a fourth pipe segment attached between the separator and a valve manifold or diverter valve configured to divert the flow of separated gas and liquid to a non-metallic pipe scraper launcher manifold or flare pit;
a fifth pipe segment attached between the non-metallic pipe scraper launcher manifold and a non-metallic pipe scraper receiver manifold, wherein the fifth pipe segment is configured to send a commingled flow of gas and liquid, and
a connection between the non-metallic pipe scraper receiver manifold and a pipeline connected to an energy production network, wherein the non-metallic pipe scraper receiver manifold is configured to send the commingled flow of gas and liquid through the connection to the pipeline controlled by a valve,
wherein the fifth pipe segment is a non-metallic pipe having one or more non-metallic pipe segments in parallel configured to send gas and liquid separately to the pipeline of the energy production network.

2. The system of claim 1, further comprises a portable generator configured to supply electricity to at least one air compressor.

3. The system of claim 1, further comprises at least one compressor configured to supply compressed air to an emergency shut down (ESD).

4. The system of claim 1, further comprises one or more couplings between two non-metallic pipes configured to install two non-metallic pipe ends together.

5. The system of claim 4, wherein the non-metallic pipe ends are inserted into the couplings using a mandrel insertion press.

6. The system of claim 1, further comprises at least one flange between a non-metallic pipe and a non-metallic pipe scraper launcher manifold or non-metallic pipe scraper receiver manifold for end connections.

7. The system of claim 4, wherein each coupling and flange comprises one or more vent holes configured to release the gas that permeates via an inner layer of the non-metallic pipe.

8. The system of claim 4, further comprises a portable crimping tool configured to crimp the couplings and flange and the non-metallic pipe.

9. A method for zero-flare energy production operation, comprising:
attaching a wellhead to an oil well or a gas well;
placing a first pipe segment between the wellhead and a first valve, wherein the first pipe segment is configured to transport gas and liquid extracted from the gas well and oil well;
placing a second pipe segment between the first valve and a choke valve manifold, wherein the second pipe segment is configured to transport gas and liquid delivered from the first pipe segment through the first valve;
placing a third pipe segment between the choke valve manifold and a separator, wherein the separator is configured to separate gas and liquid delivered from the third pipe segment;
placing a fourth pipe segment between the separator and a valve manifold or diverter valve configured to divert the flow of separated gas and liquid to a non-metallic pipe scraper launcher manifold or flare pit;
placing a fifth pipe segment between the non-metallic pipe scraper launcher manifold and a non-metallic pipe scraper receiver manifold, wherein the fifth pipe segment is configured to send gas and liquid, wherein the fifth pipe segment is a non-metallic pipe having one or more non-metallic pipe segments in parallel configured to send gas and liquid separately to the pipeline of the energy production network; and
transporting gas and liquid through the pipe segment to an energy production network.

10. The method of claim 9, wherein transporting gas and liquid through the pipe segment comprises transporting a commingled flow of gas and liquid.

11. The method of claim 9, providing a connection between the non-metallic pipe scraper receiver manifold and a pipeline to the energy production network.

12. The method of claim 9, wherein the non-metallic pipe scraper receiver manifold is configured to send the commingled flow of gas and liquid through the connection to the pipeline controlled by a valve.

13. The method of claim 9, utilizes a portable generator configured to supply electricity to at least one air compressor.

14. The method of claim 13, wherein the at least one compressor is configured to supply compressed air to the emergency shut down (ESD).
